(19) United States
(12) Patent Application Publication
(10) Pub. No.: US 2014/0358479 A1
(43) Pub. Date: Dec. 4, 2014

(54) STORAGE UNIT PERFORMANCE ADJUSTMENT

(71) Applicant: Hewlett-Packard Development Company, L.P., Houston, TX (US)

(72) Inventors: Siamak Nazari, Mountain View, CA (US); Doug Cameron, Santa Cruz, CA (US); Zhaozhong Ni, Bellevue, WA (US)

(21) Appl. No.: 13/907,807

(22) Filed: May 31, 2013

(51) Int. Cl. G06F 11/30

(52) U.S. Cl. CPC G06F 11/3006
USPC 702/183

(57) ABSTRACT

Disclosed herein are a system, non-transitory computer readable medium and method for managing storage workloads. The performance of a storage unit is adjusted if the storage unit contributes to a nonconformity or violation of a performance policy.

### BACKGROUND

Software programs heretofore may access data stored in a variety of storage devices from different manufacturers. Such storage devices may be distributed throughout a network. One way to cope with diverse storage devices is to generate a level of abstraction thereover to portray an appearance of a uniform file system. These storage systems may include quality of service (“QoS”) features that permit competing input and output (“IO”) requests to be managed.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, storage systems today may include QoS features that allow competing IO requests to be managed. Block storage systems may be deployed as a network or cluster of storage units. Each storage unit may be a node in the cluster and may be configured as a standalone server comprising a locally attached disk drive and an operating system. The network may appear as one unified storage system to a user. A QoS specification may define a performance policy that governs the cluster of storage units such that the workloads are managed in accordance with the specification. Thus, any preconfigured QoS specifications (e.g., IO rate limits, bit rate limits etc.) are typically enforced across the network of storage units. However, conventional QoS solutions may include one QoS controller that manages all IO requests for the entire cluster. Unfortunately, having a centralized QoS controller in a clustered block storage system may defeat the performance advantages of clustering, since the performance of the cluster may depend on the performance of the single QoS controller. An overburdened or malfunctioning QoS controller may hinder the performance of the entire system.

In view of the foregoing, disclosed herein are a system, computer-readable medium, and method for managing the performance of a storage system. In one example, the performance of a storage unit in a cluster may be adjusted if the storage unit contributes to a violation of a performance policy. In another example, each storage unit in the cluster may comprise a QoS controller. Thus, rather than using one QoS controller to manage the performance of the entire system, multiple controllers may be distributed across the cluster. In another example, the storage units may transmit performance statistics therebetween such that each storage unit may determine the collective performance of the cluster. The aspects, features and advantages of the present disclosure will be appreciated when considered with reference to the following description of examples and accompanying figures. The following description does not limit the application; rather, the scope of the disclosure is defined by the appended claims and equivalents.

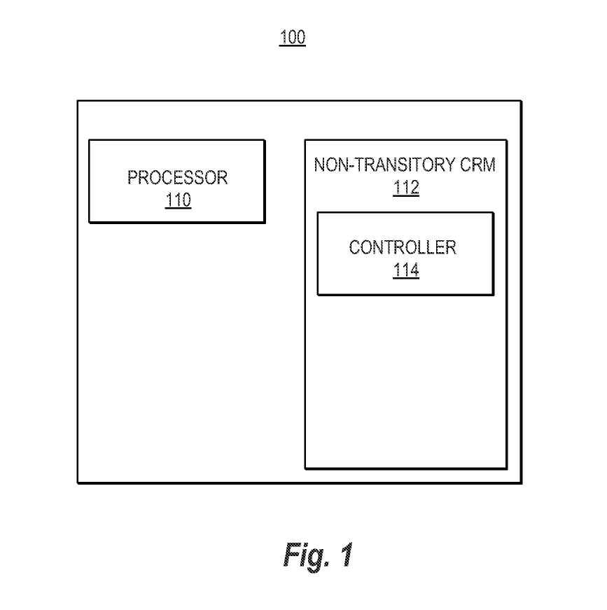

FIG. 1 presents a schematic diagram of an illustrative computer apparatus 100 for executing the techniques disclosed herein. The computer apparatus 100 may be a node in a cluster of similarly configured computers. Computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other computers over a network. The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a controller 114. Non-transitory CRM 112 may be used by or in connection with any instruction execution system that can fetch or obtain the logic from non-transitory CRM 112 and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative. A hardware implementation of controller 114 may comprise an integrated circuit or an expansion card that interfaces with computer apparatus 100 such that the circuitry therein carries out the techniques of the present disclosure.

As noted above, computer apparatus 100 may be used as a storage unit in a cluster of storage units. Thus, in one example, controller 114 may transmit local performance statistics of the storage unit to at least one other controller in at least one other storage unit in the cluster. Furthermore, controller 114 may receive and analyze remote performance statistics from at least one other controller in at least one other storage unit in the cluster. Controller 114 may determine whether the local performance statistics and the remote performance statistics indicate that the storage unit (e.g., computer apparatus 100) at least partially contributes to a performance policy committed by the plurality of storage units in the cluster. If the local performance statistics and the remote performance statistics indicate that the storage unit at least partially contributes to a violation of the performance policy, controller 114 may adjust the performance of the storage unit.

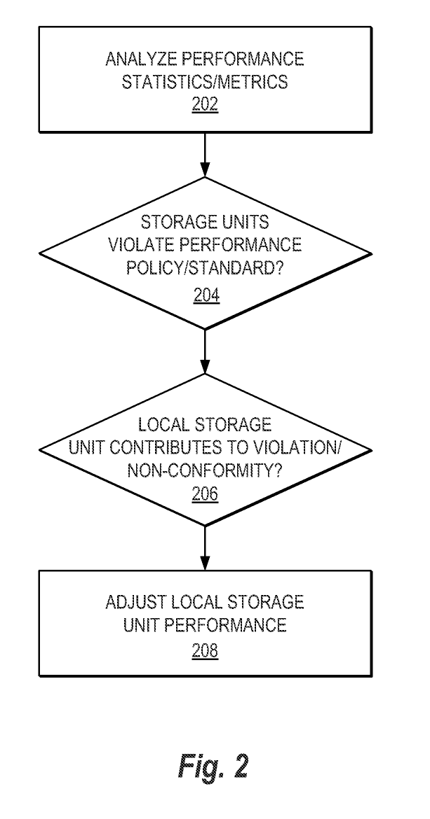

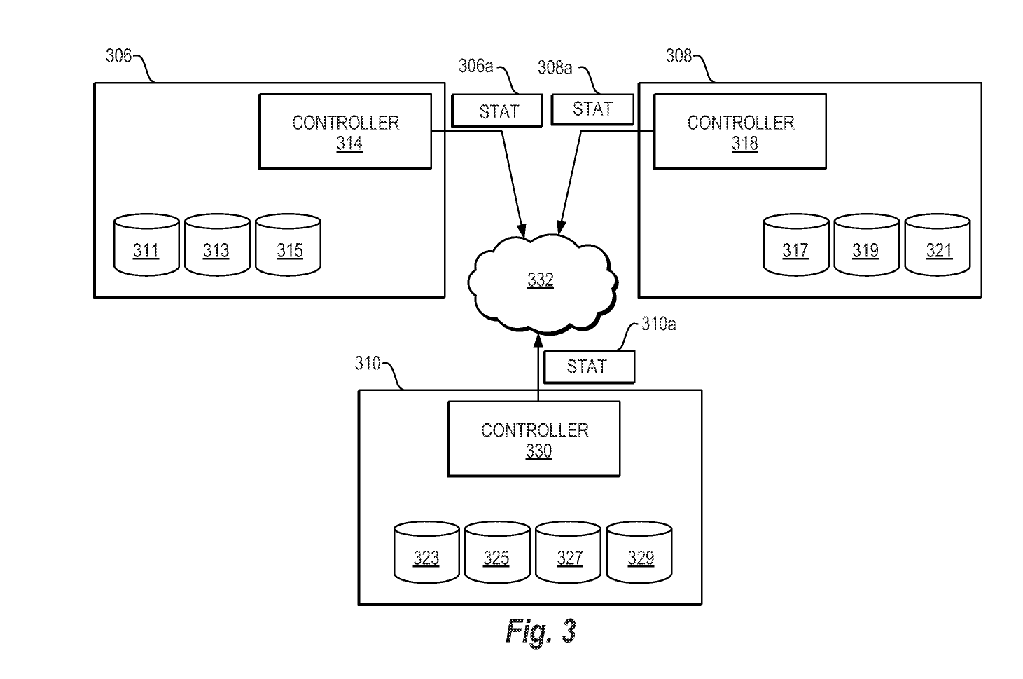

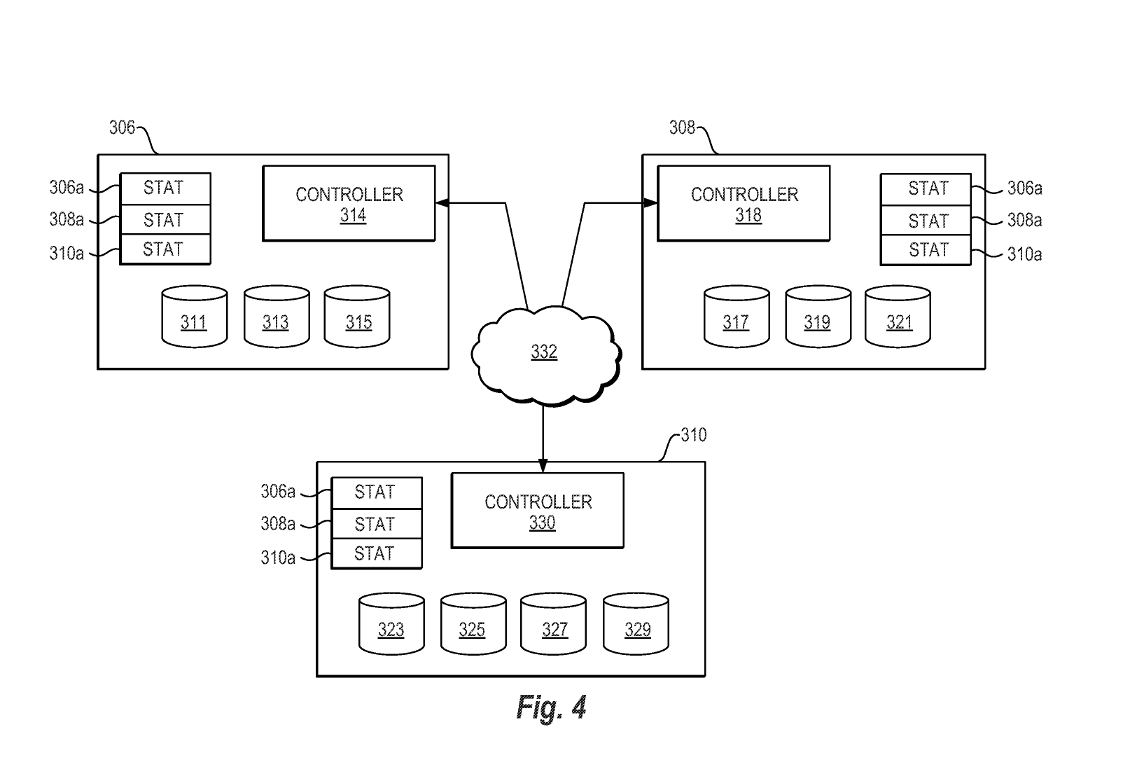

Working examples of the system, method, and non-transitory computer-readable medium are shown in FIGS. 2-4. In particular, FIG. 2 illustrates a flow diagram of an example method 200 for managing the performance of a storage system. FIGS. 3-4 each show a working example in accordance with the techniques disclosed herein. The actions shown in FIGS. 3-4 will be discussed below with regard to the flow diagram of FIG. 2.

As shown in block 202 of FIG. 2, performance statistics or metrics of a remote storage unit and a local storage unit may be analyzed. Referring now to FIG. 3, an example cluster comprising three illustrative storage units are shown. In this example, each storage unit is a volume server. FIG. 3 illustrates a cluster of three volume servers 306, 308, and 310. Although only three storage units are depicted in FIG. 3, it should be appreciated that a typical block storage system may include a larger number of interconnected servers, with each different server being at a different node of the network. In the example of FIG. 3, each volume server may comprise a logical storage unit that may be presented directly for use by a data consumer. In one example, a data consumer may be defined as a program that writes and reads data to and from a storage system (e.g., a database application). While this example uses volume servers, it is understood that each storage unit may be arranged as another type of logical storage unit (e.g., domains, domain sets, hosts, host sets etc.), and that the volume servers are used for illustrative purposes. Through the use of block device virtualization, each volume server in the cluster may be associated with several physical block devices. In the example of FIG. 3, volume server 306 is associated with physical block devices 311,313, and 315; volume server 308 is associated with physical block devices 317, 319, and 321; and, volume server 310 is associated with physical block devices 323, 325, 327, and 329. It should be understood that each volume server may be associated with any number of physical block devices than the number of devices shown in the example of FIG. 3.

The associated physical block devices shown in FIG. 3 may comprise hardware or software entities that provide a collection of linearly addressed data blocks that can be read from or written to. For example, physical block devices 311, 313, and 315 of volume server 306 may collectively represent a disk drive, a fixed or removable magnetic media drive (e.g., hard drives, floppy or Zip-based drives), writable or read-only optical media drives (e.g., CD or DVD), tape drives, solid-state mass storage devices, or any other type of storage device. In another example, the physical block devices may be a storage device residing on a storage network, such as a Small Computer System Interface (“SCSI”) device presented to a Storage Area Network (“SAN”) using a Fibre Channel, Infiniband, or Internet Protocol (“IP”) interface. In yet a further example, the physical block devices within a volume server may be a logical or virtual storage device resulting from mapping a block to one or more physical storage devices. Each volume server 306, 308, and 310 may establish the logical arrangement of the data in their respective physical storage devices. For example, the logical arrangement may indicate how the respective physical block devices are divided, striped, mirrored, etc. As noted above, a consumer of data may access the physical devices via the volume servers.

Referring back to FIG. 2, it may be determined whether the cluster of storage units violates or does not conform to a predetermined performance policy or performance standard, as shown in block 204. Such determination may be made by the controller of each storage unit based on remote performance statistics and local performance statistics. The statistics may comprise a number of input and output transactions executed by the local storage unit and the remote storage units. In another example, the local performance statistics and the remote performance statistics may comprise a quantity of data provided to a data consumer. In yet a further example, the local performance statistics and the remote performance statistics may be the most recent performance indication of the local and remote storage units. In one aspect, a most recent performance indication may be within milliseconds. In this instance, the statistics may be transmitted several times a second. The statistics may be retrieved using conventional monitoring tools, such as, for example, the system activity report (“SAR”) tool available in a UNIX environment.

Referring back to FIG. 2, if the cluster of storage units violates a predetermined performance policy or performance standard, it may be determined whether the local storage unit contributes to the violation, as shown in block 206. If the local storage unit contributes to the violation or the non-conformity, the performance of the local storage unit may be adjusted, as shown in block 208. Such an adjustment may include changing the bit rate per second, changing the number of IO operations allowed per second, or changing the quantity of data provided to a data consumer. Referring back to the example in FIG. 3, each controller in each volume server is shown transmitting their respective local statistics 306a, 308a, and 310a over network 332. In one example, network 332 may comprise a full-mesh high speed link such that the statistics are exchanged at a high frequency. Such network configuration may ensure that the statistics being transmitted do not hinder the cluster's performance. A given storage unit may collect its own local performance statistics that correspond to each performance policy. In a further example, performance statistics relevant to the cluster wide performance policy may be transferred to other nodes over network 332 via small, fixed-size packets.

Referring now to the example in FIG. 4, each storage unit 306, 308, and 310 is shown containing remote and local statistics 306a, 308a, and 310a. As such, the statistics contained throughout the cluster may be consistent to ensure that the resulting analysis across the system is uniform. A given storage unit may perform an analysis of the remote statistics and the local statistics to determine if the cluster is violating the performance policy and whether the given storage unit is contributing to the violation. The controller of a respective storage unit (e.g., controller 314, controller 318, or controller 330) may adjust the performance of the respective storage unit accordingly, if it contributes to the violation or nonconformity.

Advantageously, the foregoing system, method, and non-transitory computer readable medium may distribute the performance monitoring and adjustment of a cluster of storage units. In this regard, rather than using one centralized controller, multiple controllers may be distributed to exploit the performance advantages of clustering. Furthermore, transmission of the statistics may be carried out via a full-mesh high speed link, to ensure that the transmission of the performance statistics do not hinder the cluster. In turn, the techniques disclosed herein may permit users to experience stable and steady performance of their critical applications.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a plurality of storage units, the storage units to be governed by a predetermined performance policy, each storage unit comprising a quality of service controller such that a given controller to:
transmit local performance statistics of a given storage unit to at least one other controller in at least one other storage unit;
analyze remote performance statistics received from at least one other controller in at least one other storage unit; and
adjust a performance of the given storage unit, if the local performance statistics and the remote performance statistics indicate that the given storage unit at least partially contributes to a violation of the performance policy committed by the plurality of storage units.

2. The system of claim 1, wherein the local performance statistics and the remote performance statistics comprise a number of input and output transactions executed by the given storage unit and the remote storage units.

3. The system of claim 1, wherein the local performance statistics and the remote performance statistics comprise a quantity of data provided to a data consumer.

4. The system of claim 1, wherein the local performance statistics and the remote performance statistics to be a most recent performance indication of the given storage unit and the at least one other storage unit.

5. The system of claim 1, wherein the local performance statistics and the remote performance statistics are to be synthetic data.

6. The system of claim 1, wherein the given controller further to transmit the local performance statistics of the given storage unit in response to a request for the local performance statistics by the at least one other controller.

7. A non-transitory computer readable medium having instructions therein which, if executed, cause at least one processor to:
obtain local performance statistics associated with a local storage unit belonging to a cluster of storage units;
analyze remote performance statistics associated with at least one remote storage unit in the cluster of storage units;
determine whether the cluster conforms to a predefined performance standard, based at least partially on the local performance statistics and the remote performance statistics; and
if the cluster does not conform to the standard, adjust a performance of the local storage unit, if the local statistics and the remote statistics indicate that the local storage unit at least partially contributes to the nonconformity.

8. The non-transitory computer readable medium of claim 7, wherein the local performance statistics and the remote performance statistics comprise a number of input and output transactions executed by the local storage unit and the remote storage units.

9. The non-transitory computer readable medium of claim 7, wherein the local performance statistics and the remote performance statistics comprise a quantity of data provided to a data consumer.

10. The non-transitory computer readable medium of claim 7, wherein the local performance statistics and the remote performance statistics to be a most recent performance indication of the local storage unit and the at least one remote storage unit.

11. The non-transitory computer readable medium of claim 7, wherein the local performance statistics and the remote performance statistics to be synthetic data.

12. The non-transitory computer readable medium of claim 7, wherein the instructions therein, if executed, further cause at least one processor to transmit the local performance statistics to the at least one remote storage unit in the cluster of storage units.

13. A method comprising
transmitting, using at least one processor, local performance metrics to a plurality of remote storage units, the local performance metrics being associated with a local storage unit, the local storage unit and the plurality of remote storage units being connected to a cluster of storage units;
analyzing, using at least one processor, the local performance metrics and remote performance metrics of the remote storage units to determine whether the cluster violates a predefined performance policy that governs a performance of the cluster; and
if the cluster violates the policy, adjusting, using at least one processor, a performance of the local storage unit, if the local metrics and the remote metrics indicate that the local storage unit at least partially contributes to the policy violation.

14. The method of claim 13, wherein the local performance metrics and the remote performance metrics comprise a number of input and output transactions executed by the local storage unit and the remote storage units.

15. The method of claim 13, wherein the local performance metrics and the remote performance metrics comprise a quantity of data provided to a data consumer.

16. The method of claim 13, wherein the local performance metrics and the remote performance metrics to be a most recent performance indication of the local storage unit and the remote storage units.

17. The method of claim 13, wherein the local performance metrics and the remote performance metrics to be synthetic data.

18. The method of claim 13, wherein the local performance metrics are transmitted in response to a request by at least some of the plurality of remote storage units.
